(19) United States
(12) Patent Application Publication
(10) Pub. No.: US 2021/0208583 A1
(43) Pub. Date: Jul. 8, 2021

(54) Method and System for Deriving a Trajectory at a System Boundary of an Automatically Operable Vehicle

(71) Applicant: Daimler AG, Stuttgart (DE)

(72) Inventors: Christoph G. KELLER, Stuttgart (DE); Holger MIELENZ, Ostfildern (DE)

(73) Assignee: Daimler AG, Stuttgart (DE)

(21) Appl. No.: 17/057,900

(22) PCT Filed: May 16, 2019
(86) PCT No.: PCT/EP2019/062710

§ 371 Date: Nov. 23, 2020

(30) Foreign Application Priority Data
May 24, 2018 (DE) 10 2018 112 513.5

(51) Int. Cl. G05D 1/00; B60W 60/00

(52) U.S. Cl. CPC G05D 1/0038; B60W 60/0015

(57) ABSTRACT

A method for requesting support of a teleoperator by a control device of an automatically operable vehicle includes receiving and evaluating measurement data of a vehicle sensor system of the automatically operable vehicle, determining a system boundary of the automatically operable vehicle on a basis of the evaluated measurement data of the vehicle sensor system, sending an environmental situation and a previous trajectory of the automatically operable vehicle to the teleoperator by the automatically operable vehicle, and receiving data by the control device from the teleoperator for approving the previous trajectory of the automatically operable vehicle or for designating a driveable area. The control device generates control commands for continuing the previous trajectory of the automatically operable vehicle or a new trajectory is calculated based on the received data from the teleoperator and control commands for driving on the new trajectory are generated.

### BACKGROUND AND SUMMARY OF THE INVENTION

The invention relates to a method for requesting support of a teleoperator by a control device of an automatically operable vehicle, as well a vehicle system for ensuring a trajectory. Furthermore, the invention relates to a control device, a computer program and a machine-readable storage medium.

Different methods for calculating trajectories of automatically operable vehicles are known. In particular, environmental information is collected by the automatically operable vehicle, and a trajectory is calculated based on the collected environmental information within the vehicle. The environmental information is determined by means of a vehicle sensor system, for example by evaluating a depiction of the environment. Based on the environmental information, the vehicle control system can generate the control tasks in the longitudinal and transverse guide and thus control the automatically operable vehicle along the trajectory.

Methods that operate at a system boundary of an automatically operable vehicle are not known here. In particular, system boundaries can be situations that are borderline with respect to a further control and/or environmental detection. In such situations, for example, the automatically operable vehicle may not be able to continue an automated journey due to restrictions in environmental detection or behavior planning.

The object underlying the invention can be seen in proposing a method and a vehicle system that can reduce the downtime of an automatically operable vehicle and allow an emergency methodology at system boundaries.

According to one aspect of the invention, a method for requesting support of a teleoperator by a control device of an automatically operable vehicle is provided. The automatically operable vehicle has, for example, a communication unit for establishing a communication link with a control unit external to the vehicle which is controlled by a teleoperator. The method can use at least one automatically operable vehicle with a communication unit for establishing a communication link as well as a vehicle external control unit controlled by a teleoperator.

In one step, measurement data from a vehicle sensor system are received and evaluated. Based on the evaluated measurement data of the vehicle sensor system, a system boundary of an automatically operable vehicle is determined.

Subsequently, a situation of the vehicle environment and a previous trajectory of the automatically operable vehicle are transmitted to the teleoperator.

Data for approving the previous trajectory or for designating a driveable area are received by the control device from the teleoperator. In a further step, control commands for continuing the previous trajectory of the automatically operable vehicle are generated by the control device or a new trajectory is calculated based on the information received from the teleoperator and control commands for driving on the new trajectory are generated.

According to a further aspect of the invention, a control device is provided, wherein it is set up to carry out the method. The control device can preferably be connectable to the communication unit and the at least one sensor by the data line. Furthermore, the control device is set up to generate control commands which can influence the vehicle control and thus the transverse and longitudinal guide of the automatically operable vehicle.

In addition, according to one aspect of the invention, a computer program is provided which comprises instructions which, when the computer program is executed by a computer or a control device, cause the method according to the invention to be carried out. According to a further aspect of the invention, a machine-readable storage medium is provided on which the computer program according to the invention is stored.

The automatically operable vehicle can in particular be a means of passenger transport, such as a shuttle or a so-called robotaxi. The automatically operable vehicle can also be a commercial vehicle, transport vehicle, agricultural vehicle and similar. The automatically operable vehicle can preferably be operated in an assisted, partially automated, highly automated and/or fully automated or driverless manner according to the BASt standard. In particular, automatically operable vehicles may be classified as SAE level 4 or 5 vehicles according to the SAE J3016 standard.

A predictive detection of a system boundary by means of the automatically operable vehicle can take place. A system boundary can be in the area of the vehicle perception or in the area of a situation analysis. By way of example, obstacles can be recognized as not being able to be driven over or they can cover a roadway and thus make it more difficult. Such obstacles can be autumn leaves, rubbish, harvest products, animals on the road, lost cargo and similar. Roadways can be made difficult or impeded by snow, autumn foliage, dirt, dust, sand drifts or wet surfaces.

In addition, a road surface may not be correctly assessed by a vehicle system or may be interpreted as non-driveable. By way of example, a dirt road or gravel path can be confused with a meadow. Agriculturally used paths, tar seams, texture transitions, such as cobblestones, can also make it difficult for the automatically operable vehicle to interpret a driveable road.

Before such a system boundary, the automatically operable vehicle can preferably stop and transmit the environmental situation of the vehicle to the vehicle's external control unit via the communication link. The transmitted data can include a planned path or planned trajectory of the automatically operable vehicle, in addition to environmental data, such as video data, LIDAR data, radar data and similar. In particular, such information can be transmitted to the teleoperator which allows a third party or the teleoperator to reliably assess the environmental situation of the vehicle.

The method according to the invention enables a teleoperator of an automatically driving vehicle to highlight or select an area in a transmitted image of the automatically driving vehicle, such that the automatically operable vehicle can, for example, calculate a new trajectory downstream in order to follow its continuing route. The highlighting of an area can be done, for example, by drawing or marking a section in an image transmitted by the vehicle. In particular, the teleoperator can highlight a surface or area that can be driven over directly by the vehicle or communicate this to the vehicle. An area identified by the teleoperator can be used by the automatically operable vehicle to calculate a new trajectory within the area.

Based on the information transmitted by the teleoperator to the automatically operable vehicle, the vehicle can re-determine its trajectory with knowledge of freely driveable areas. By means of an existing environmental detection, the automatically operable vehicle can further check this approved area for the absence of problematic objects or surfaces and follow a newly calculated trajectory. After the assisted passing of the system boundary, the vehicle can follow its newly calculated route or continue on the original route.

Alternatively or additionally, the teleoperator can compare the transmitted previous trajectory with a vehicle environment and approve it for an unchanged continuation of the journey. For this purpose, the teleoperator can access the vehicle sensors via the communication link and check the system boundary or the borderline situation.

By means of the method according to the invention, further information can be made available to the automatically operably vehicle within a system boundary, such that an automated continuation of the journey is made possible. In particular, a fall-back method or an emergency plan is provided to an automatically operable vehicle, which enables the automatically operable vehicle to continue its journey.

In particular, the method can prevent automatically operable vehicles from breaking down at system boundaries. Furthermore, such situations can be solved without manually performed journeys to pick up the broken down vehicle. Furthermore, operating costs of a fleet of automated vehicles can be reduced, since fewer drivers are needed and the automatically operable vehicles are available for longer periods of time.

According to an exemplary embodiment of the method, before reaching the system boundary, control commands are generated by the control device of the automatically operable vehicle to stop or slow down the automatically operable vehicle. In this way, a time period can be generated which is provided to a teleoperator to react to the system boundary. In particular by stopping or slowing down the automatically operable vehicle, dangerous situations can be avoided or a risk can be reduced by the automatically operable vehicle.

According to a further exemplary embodiment of the method, the environmental situation of the vehicle is transmitted to the teleoperator in the form of one or more images. Based on the images, the teleoperator can reproduce the situation of the automatically operable vehicle and check which areas of the vehicle environment are driveable. In this way, system boundaries can be technically easily resolved. By way of example, the teleoperator can be a vehicle owner or an employee of a service provider. The control unit external to the vehicle can be a mobile or stationary control center or a portable device, such as a tablet or a smartphone.

According to a further exemplary embodiment of the method, the at least one image is transformed before a transmission through the communication link into a coordinate system of the automatically operable vehicle by a control unit of the automatically operable vehicle. Preferably, the image determined by the automatically operable vehicle can be transformed into an ego coordinate system before transmission via the communication link, such that the objects contained there have a reference coordinate system and the ego or the automatically operable vehicle can estimate the distance relations more efficiently.

According to a further exemplary embodiment of the method, the new trajectory is calculated by the control unit on the vehicle side based on data received from the teleoperator with a selection of a driveable area. This results in a recalculation of the trajectory based on a restricted driveable area. Due to the reduced possibilities offered by the restricted and driveable area, the automatically operable vehicle can reliably calculate the trajectory. The recalculation of the trajectory is preferably carried out by the control unit on the vehicle side.

According to a further exemplary embodiment of the method, the new trajectory is calculated based on the selection of the driveable area by the teleoperator and received by the vehicle control unit via the communication link. Alternatively or additionally, a trajectory or a route of the vehicle can be determined by the teleoperator. This can be a complete recalculation of the entire route or a route to cross the system boundary. In this way, a reliable route planning can be carried out, in which the automatically operable vehicle can at least partially or temporarily follow a trajectory determined externally to the vehicle. After overcoming the system boundary, the automatically operable vehicle can again independently adjust the necessary trajectory or continue to drive on it.

According to a further exemplary embodiment of the method, the approval of the previous trajectory or a designation of a driveable area is carried about area by area by the teleoperator and received by the control unit. In a further embodiment, the method according to the invention can also be applied iteratively and repeatedly in order to allow a longer route to be approved by the teleoperator. This procedure can be advantageous if, for example, a critical area cannot be covered with a one-time approval or with an image by the environmental detection on the vehicle side. In such a case, the teleoperator cannot detect an end of the system boundary or the problematic area the first time. In this case, the automatically operable vehicle can arrive at the end of a first area approved by the teleoperator and can then have another area approved by the teleoperator.

According to a further exemplary embodiment of the method, control commands from the teleoperator for deactivating or transferring the automatically operable vehicle to a secure state are received by the communication link. Depending on the situation, it may be necessary to deactivate or secure the automatically operable vehicle. This may be necessary, for example, if the vehicle sensors are faulty or if there is a critical fault in the vehicle's internal control unit. By transferring the vehicle to the secure state, the automatically operable vehicle can, for example, head for a roadside or a neighboring car park. Depending on the error or the system boundary, a last resort may be to deactivate the vehicle. Preferably, a hazard warning light of the automatically operable vehicle is activated to warn following traffic. In this way, a risk can be minimized by the automatically operable vehicle.

According to a further aspect of the invention, a vehicle system is provided for ensuring a trajectory and for carrying out the method according to the invention. The vehicle system has at least one automatically operable vehicle having a vehicle sensor system for detecting a vehicle environment, having a control unit for evaluating the vehicle sensor system and for controlling the vehicle, and having a communication device. Furthermore, the vehicle system has at least one control unit external to the vehicle having at least one teleoperator for establishing a communication link to the communication unit of the at least one automatically operable vehicle, wherein a communication link is established in the event of a borderline situation or system boundary determined by the at least one vehicle and the system boundary is solved by the at least one teleoperator at least in certain areas or temporarily.

The vehicle system according to the invention can provide an emergency strategy to an automatically operable vehicle, in which, for example, a critical situation or a situation which is problematic for the vehicle sensors does not have to lead to the vehicle being switched off. In most such situations, the use of a teleoperator can solve the system boundary based on manual instructions to the automatically operable vehicle. This can prevent the automatically operable vehicle from breaking down and increase the operating time.

In the following, preferred exemplary embodiments of the invention are explained in detail by means of highly simplified schematic depictions.

### BRIEF DESCRIPTION OF THE DRAWINGS

FIG. 1 is a schematic depiction of a vehicle system having a recognized system boundary to illustrate the method according to the invention; and

FIG. 2 is a schematic depiction of the vehicle system having a drivable area selected by a teleoperator.

### DETAILED DESCRIPTION OF THE DRAWINGS

In the Figures, the same design elements have the same reference numerals.

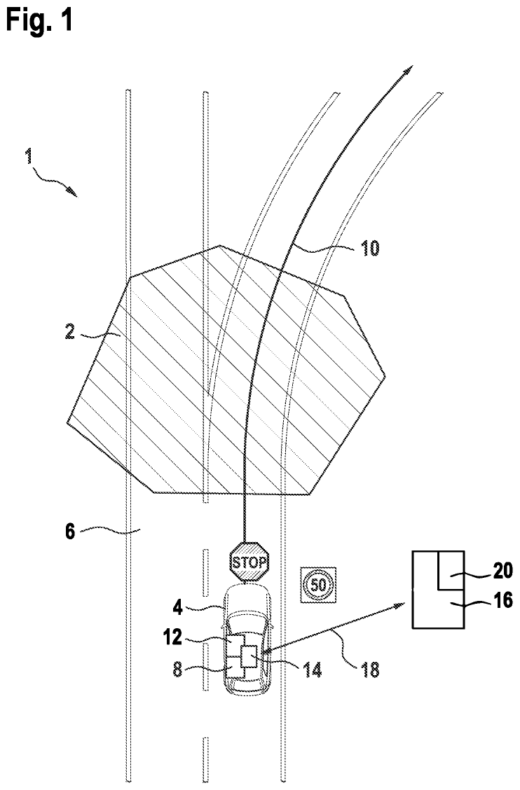

In FIG. 1, a schematic depiction of a vehicle system 1 having a recognized system boundary 2 to illustrate the method according to the invention is shown.

For simplicity, the vehicle system 1 has a vehicle 4 which is automatically operable. The vehicle 4 has recognized, with foresight, a system boundary 2. The system boundary 2 is an area which the vehicle 4 cannot classify as driveable/crossable on its own or even cannot detect the further track course of a roadway 6 because of this area 2.

The system boundary 2 is designed here in the form of a roadway 6 covered by dirt, such that a vehicle-internal control device 8 cannot follow the road without errors. The previous or originally planned trajectory 10 leads through the area 2 which is recognized by the vehicle 4 as not driveable. The environmental detection of the vehicle environment occurs by means of a vehicle sensor system 12. The vehicle sensor system 12 can consist of camera sensors, LIDAR sensors and/or radar sensors, for example.

The control device 8 recognizes the system boundary 2 at an early stage and then stops the vehicle 4. The information determined by the vehicle sensor system 12 is then sent to an external control unit 16 with the aid of a communication unit 14. The communication link 18 between the communication unit 14 on the vehicle side and the external control unit 16 occurs according to the exemplary embodiment based on a mobile radio standard. This can be a GSM, UMTS or LTE transmission standard, for example. The external control unit 16 is monitored and controlled by a teleoperator 20.

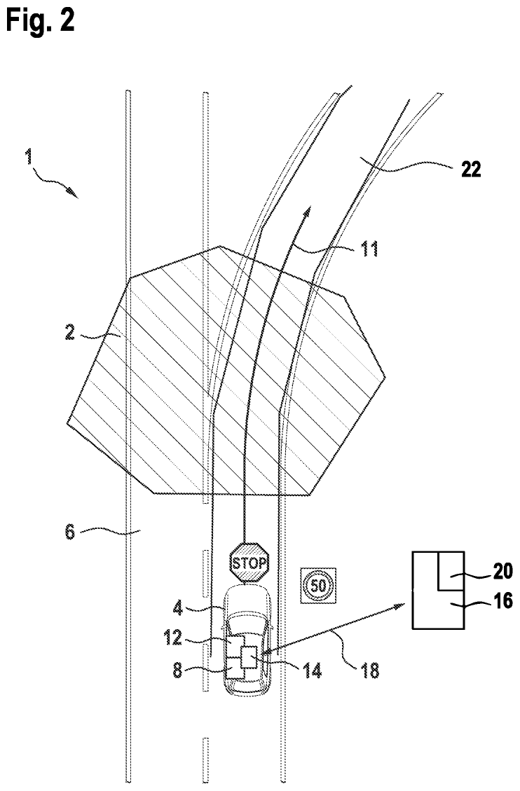

FIG. 2 shows a schematic depiction of the vehicle system 1 having a driveable area 22 selected by a teleoperator 20. The teleoperator 20 can thereby understand, based on the information transmitted by the communication link 18, which areas are driveable and in which direction the vehicle 4 plans to continue. The information can be, for example, video data from the vehicle sensor system 12 of the automatically operable vehicle 4. The teleoperator 20 can mark the driveable area 22 in such a way that the control device 8 can calculate a new trajectory 11 based on this restricted area 22 in order to be able to continue to follow the planned route 10. The recalculated trajectory 11 can also have evasive manoeuvres and driving on unplanned detours.

1.-12. (canceled)

13. A method for requesting support of a teleoperator by a control device of an automatically operable vehicle, comprising the steps of:
receiving and evaluating measurement data of a vehicle sensor system of the automatically operable vehicle;
determining a system boundary of the automatically operable vehicle on a basis of the evaluated measurement data of the vehicle sensor system;
sending an environmental situation and a previous trajectory of the automatically operable vehicle to the teleoperator by the automatically operable vehicle;
receiving data by the control device from the teleoperator for approving the previous trajectory of the automatically operable vehicle or for designating a driveable area; and
generating by the control device control commands for continuing the previous trajectory of the automatically operable vehicle or calculating a new trajectory based on the received data from the teleoperator and generating control commands for driving on the new trajectory.

14. The method according to claim 13 further comprising the step of generating control commands for stopping or slowing down the automatically operable vehicle before reaching the system boundary.

15. The method according to claim 13, wherein the environmental situation is sent to the teleoperator in a form of an image.

16. The method according to claim 15, wherein the image is transformed by the control device of the automatically operable vehicle into a coordinate system of the automatically operable vehicle.

17. The method according to claim 13, wherein the new trajectory is calculated by the control device based on a selection of a driveable area.

18. The method according to claim 13, wherein the new trajectory is calculated by the teleoperator based on a selection of a driveable area and is sent to the control device.

19. The method according to claim 13, wherein approval of the previous trajectory or designating the driveable area is performed area by area by the teleoperator.

20. The method according to claim 13 further comprising the step of receiving control commands of the teleoperator for deactivating or for transferring the automatically operable vehicle into a safe state.

21. A vehicle system for ensuring a trajectory and for carrying out the method according to claim 13, comprising:
an automatically operable vehicle having a vehicle sensor system for detecting a vehicle environment, a control device for evaluating the vehicle sensor system and for controlling the automatically operable vehicle, and a communication unit; and
a control unit external to the automatically operable vehicle having a teleoperator for establishing a communication link to the communication unit of the automatically operable vehicle, wherein the communication link is established in an event of a borderline environmental situation of the automatically operable vehicle determined by the automatically operable vehicle and the borderline environment situation is solved by the teleoperator.

22. A control device configured to perform the method according to claim 13.
